(19) United States
(12) Patent Application Publication
(10) Pub. No.: US 2008/0240486 A1
(43) Pub. Date: Oct. 2, 2008

(54) SYSTEM AND METHOD FOR AN EARPHONE DEVICE

(76) Inventors: Martin Garcia, Pineville, PA (US); Brian Skinner, Levittown, PA (US)

Correspondence Address: KENYON & KENYON LLP, ONE BROADWAY, NEW YORK, NY, 10004, US

(21) Appl. No.: 12/057,361

(22) Filed: Mar. 27, 2008

Related U.S. Application Data
(60) Provisional application No. 60/920,480, filed on Mar. 27, 2007.

(51) Int. Cl. H04R 1/10

(52) U.S. Cl. 381/380

(57) ABSTRACT

A system and method provide an earphone device which provides a full dynamic range of sound, including bass, to a user. The earphone device includes a transducer coupled to a nozzle, and ear fittings. The earphone device further includes an audio aperture. The aperture in the audio aperture or diaphragm cover provides a means for the acoustical energy to be fine-tuned to the nozzle.

### COPYRIGHT

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyright rights whatsoever.

### FIELD OF INVENTION

The present invention relates to an earphone device. More specifically, the present invention relates to a high quality earphone device having an audio transducer with an associated filter providing for larger bass spectrum response for a user.

### BACKGROUND

Consistent high quality production of audio transducers is a constant problem facing audio component manufacturers. Chief among the significant defects among currently produced transducers is incorrect or nonexistent bass response.

Currently, manufacturers do not have sufficient capability in either manufacturing techniques and/or overall transducer designs to allow small transducers, for use in head/earphones, for instance, to have proper bass response. The manufacturers sacrifice quality of audio playback for unit production speed as well as economic cost of production. Existing methods and devices for achieving bass response are limited to providing high quality coils and magnets. No current configurations are used to maximize bass response compared to large speaker systems commonly found on audio components speakers (i.e., non-headphone speakers). There is therefore a need to provide a transducer that will maximize bass response while being economical to produce.

Economic costs for transducer production are derived from two principle components, the material quality used and production speed for the individual unit. Manufacturers must balance the economic costs of the units produced with the production speed for the units. Currently, there are no manufacturing techniques to produce economic transducer units (i.e., that have a high unit production speed) coupled with high quality response. There is therefore a need to provide a transducer that has both high quality and high production speed coupled with proper bass response.

Transducers are prone to malfunction under various detrimental conditions including external induced vibration, temperature variation and moisture intrusion. Intrusion of foreign materials into the transducer is a special problem that manufacturers have yet to solve. Deleterious materials, such as dust, dirt and other similar materials can penetrate into the design of the transducer and prevent components from actuating. These foreign materials, for example, can limit the movement of the magnet in relation to the coil and limit the effectiveness of the moving components. Such problems are endemic to transducers and are major cause of failure for many transducer units. Manufacturing facilities for the transducers, therefore, are maintained in a clean condition to limit the possibility of materials at the outset of production, thereby increasing productive yields of the facility. Although well intentioned, such manufacturing techniques do not protect the transducers that have been exposed to such elements outside of the manufacturing facility. There is therefore a need to provide a transducer that will limit or eliminate foreign materials from entering the body of the transducer.

There is therefore a need to provide a configuration of a transducer which will eliminate the problems of material intrusion.

Conventional transducers also have other serious drawbacks. Listeners wishing to hear all aspects of music or audio being played must now currently resort to increasing the overall volume of the audio playback in order to hear an audible level of bass from the transducer. Increasing the amount of audio playback volume can damage an individuals hearing. The transducers, therefore, can lead to tinnitus and other hearing ailments.

Presently available transducers include a screen having lots of holes, and a screen on top to prevent contaminants.

There is therefore a need to provide a transducer design which will have proper bass response such that an individual listening to the audio playback is not required to increase the volume of the audio playback in order to hear correct playback response.

### BRIEF DESCRIPTION OF THE DRAWINGS

FIG. 1 shows a cross-section of an exemplary audio transducer embodiment according to the present invention.

FIG. 2 shows an exemplary earphone embodiment according to the present invention.

FIG. 3 shows a cross-section of an exemplary earphone embodiment according to the present invention.

FIG. 4 shows an exemplary earphone embodiment with example ear fittings according to the present invention.

### DETAILED DESCRIPTION

Example embodiments of the present invention provide for an earphone device which provides for a high quality audio experience. An example high quality audio experience may involve a providing a high dynamic range, low distortion, and/or extended bass capabilities. An example high quality audio experience may involve a user receiving a full bass sound through use of the earphone device. An example high quality audio experience may involve a user being able to listen to a playback of a recording with less than typical volume needed in order to maximize a fuller range of sound received. An example high quality audio experience may involve an earphone device providing an improved sound quality via an efficient and elegant solution. An example high quality audio experience may involve an earphone device which is economical to manufacture due to its efficient and elegant solution.

In an example embodiment of the present invention, a transducer system is provided which allows for both high quality and high production speed coupled with an improved bass response over the existing art.

In an example embodiment of the present invention, a transducer system is provided which, by use of its solution, prevents foreign materials from entering the transducer system and minimize internal component damage.

In an example embodiment of the present invention, a transducer system is provided in which a minimal volume of an audio playback is needed so as to observe an extended bass response.

In an example embodiment of the present invention, a transducer system is provided in which a minimal volume of an audio playback is needed so as to observe a desired playback spectrum response.

In an example embodiment of the present invention, an earphone device is provided in which a housing of the earphone device is of a single construction. That is, the housing is a single molded entity.

The transducer may be to fit into an earpiece, for example a headphone or an earphone. The filter material is connected to the magnet through an adhesive.

The filter material may be placed on the outside of the hole in the magnet. The hole through the body of the magnet may be round.

In an embodiment, the transducer may have an impedence of approximately 32 ohms and a frequency response between 20 Hz and 20 KHz and have a noise isolation capacity of plus or minus 25 dB and an impedance of approximately 32 ohms.

In an embodiment, the transducer may have a material, e.g., foam, placed within the interior of the hollow rivet or hole formed by the magnet structure. The material may be a reticulated foam.

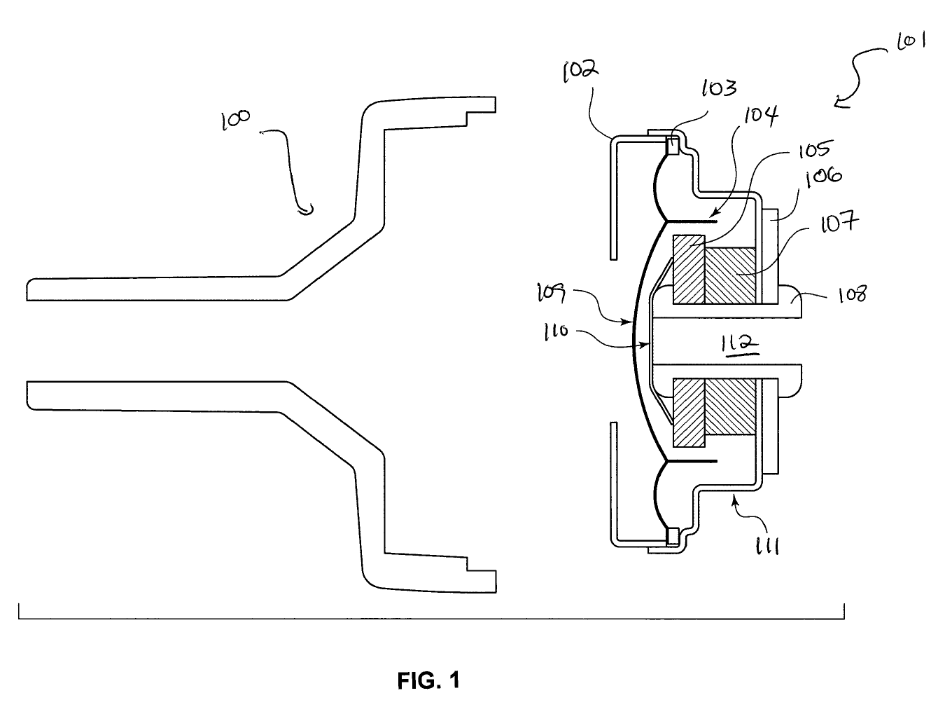

FIG. 1 shows a cross-section of an exemplary nozzle 100 and transducer 101 according to an embodiment of the present invention. The transducer 101 provides an arrangement to provide audio replay of electrical impulse signals provided to the transducer 101, for example, from a compact disk player, a digital music replay apparatus, television, telephony, or other device that incorporates the ability to use headphones, for example. The transducer 101 provides extremely high quality audio reproduction of the provided electrical input signals with minimal distortion. The transducer 101 has a frame 111, a voice coil 104, a pole piece 105, a magnet 107, a surround mounting ring 103, a diaphragm 109, a hollow rivet 108, a printed circuit board 106, a damper or acoustic filter 110, and an audio aperture or diaphragm cover 102.

The frame 111 coupled with the audio aperture 102 allows the remaining components of the transducer 101 to be housed and protected from damage through structural loading and material intrusion. The frame 111 is configured to provide impact resistance to the transducer 101 in the case of accidental impact loading, for example, dropping of the transducer 101. The frame 111 is made of, for example, steel. The frame 111 is shaped to allow the frame 111 to be incorporated into an external casing for use in audio headphones, ear buds, or other audio playback devices. The exterior surface of the frame 111, therefore, may have depressions or tabs allowing connection of the frame 111 to other apparatus. The transducer frame 111 also has non-damaging ports to allow wires to provide electrical signals to the transducer 101.

The magnet 107 provides a magnetic field which, coupled with the voice coil 104, allows for conversion of the electrical signals provided by the electrical wires into audio signals when coupled with the other components of the transducer 101. The magnet 107 has a hole 112 which extends through the body of the magnet 107. The hole 112 in the exemplary embodiment may be round or any other shape in configuration. The remainder of the magnet abuts the frame 111, the pole piece 105 and the voice coil 104.

The magnet 107 in the exemplary embodiment may be a permanent magnet. Other configurations, however, are possible including an electromagnet, and a magnet which is round-shaped, square-shaped, rectangular-shaped, or other.

The voice coil 104 may be provided with one or more electrical connections. The electrical connections allow for acceptance of electrical signals or may be imparted through the use of the printed circuit board 106. The electrical signals provided to the voice coil 104 allow the diaphragm to move inward or outward compared to the magnet. In an embodiment, the coil moves relative to the magnet. In an embodiment, the voice coil 104 is made of aluminum. Other conductive materials may be used. The winding of the voice coil 104 may be any winds per length provided the voice coil 104 provides sufficient capability to actuate the diaphragm 109.

A pole piece 105 is provided adjacent to the magnet 107 and the voice coil 104 to allow for generation of electromagnetic activity to allow the diaphragm 109 to be actuated. In an embodiment, the pole piece 105 as well as the voice coil 104 and the magnet structure are provided electricity through the use of the printed circuit board 106 connected to one end of the hollow rivet 108.

In an embodiment, a diaphragm 109 is provided as a polyester or other lightweight rigid material provided over the opening 112 in the frame 111. For example, the diaphragm could be metal. Also, the shape of the diaphragm can be round, square, rectangular, etc.

A damper or acoustic filter, e.g., a filter paper, 110 is provided in a position over the port hole of the magnet 107. The filter 110 enables the transducer 101 to produce proper frequency response when activated by the electrical signal input. The filter 110 is placed over the hole 112 of the magnet 107 to allow for the balancing of resonances from the motor structure.

In FIG. 1, a hollow rivet 108 is provided. The hollow rivet 108 extends from the diaphragm 109 through the length of the entire transducer to a distal end. The hollow rivet 108 is provided with an interior chamber 112 that may extend the length of the rivet 108.

In an embodiment of the present invention, the transducer may be a 10 millimeter unit that has an input sensitivity of ±112 dB@30 Hz/1 mW. The cable length may be 43.3 inches. A connector may also be provided such that a 3.5 millimeter (⅛″) standard stereo mini-plug. In the exemplary embodiment, the connector may have a 90 degree angle. The transducer may have a noise isolation capacity of plus or minus 25 dB. The impedance may be 32 ohms and the frequency response may be between 20 Hz and 20 KHz. Other connectors are possible as well.

The printed circuit board 106 allows for the transducer's voice coil to be connected to other electrical equipment such that electrical impulses may be input into the transducer. The printed circuit board 106 can be any such unit used in the industry to allow such electrical impulse generation to be connected to the transducer 101.

The exemplary embodiment provided in the present invention may also have a foam installation placed within a section of the hollow rivet 108 or port hole 112 or void formed by the magnet structure. The foam installation provides for resistance and may be tunable during installation by either adding or subtracting foam from the interior of the hollow rivet 108. The foam may be pressure fit or glued inside the space.

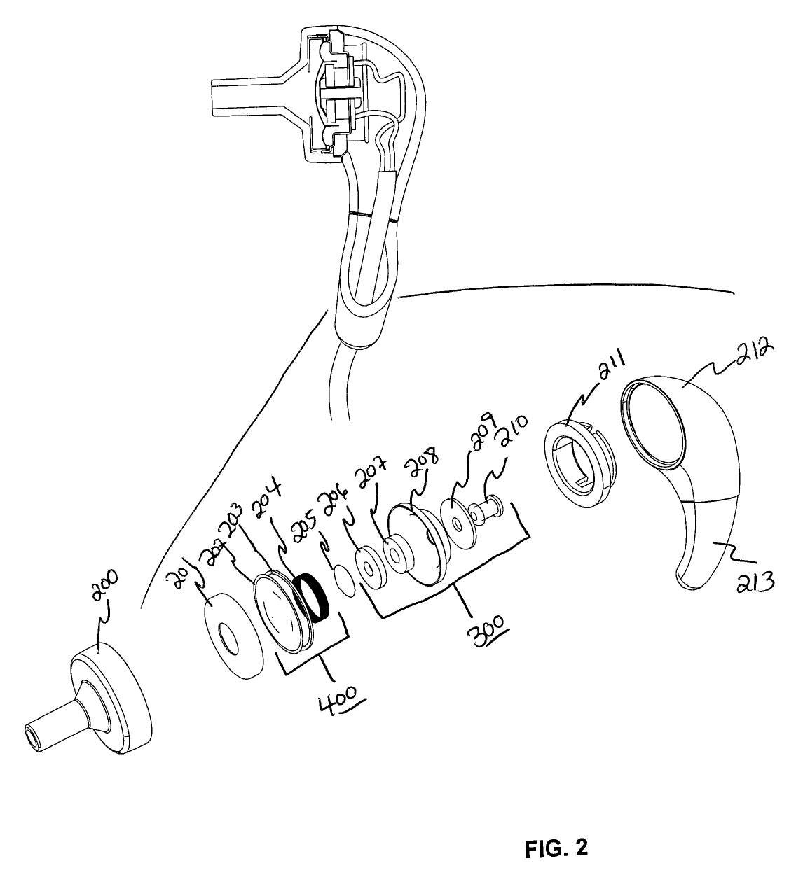

In FIG. 2, an example embodiment of an earphone device is provided. Specifically, FIG. 2, provides an exploded view of an earphone device embodiment in accordance with the present invention. The exploded view of the earphone device shows a magnet structure 300 consisting of a frame 208, axially connecting a magnet 207 and a pole piece 206. A printed circuit board 209 is provided to facilitate a convenient place to connect the writes of the voice coil 204, to a cord provided to connect the earpiece to an external source. A port hole or void is provided for through the magnet structure 300 to interact between the motor structure 400 and the rear chamber provided for by the back cap 212. In the embodiment illustrated, the magnet structure 300 is mechanically held together using a rivet 210. In other embodiments, glue or other bonding means or mechanisms may be used to hold the magnet structure 300 together. A damper 205 is mounted on the port hole of the magnet structure 300.

A motor structure 400 includes a diaphragm 202 and a voice coil 204 which are mounted to a frame 208 of the magnet structure 300. A mounting ring 203 provides structural strength or support to the diaphragm 202 during construction and during use. The mounting ring 203 further provides for mechanical placement of the motor structure 400 into the frame 208.

A diaphragm cover 201 or audio aperture mechanically holds the motor structure 400 to the magnet structure 300. An aperture in the diaphragm cover 201 provides a means for the acoustical energy to be fine-tuned to the nozzle 200. A mounting ring 211 is fitted to hold the transducer to the nozzle 200 and in addition to fit the back cap 212.

In an embodiment, the back cap 212 may be attached to a strain relief for a cord, e.g., an electrical cord leading to a sound device.

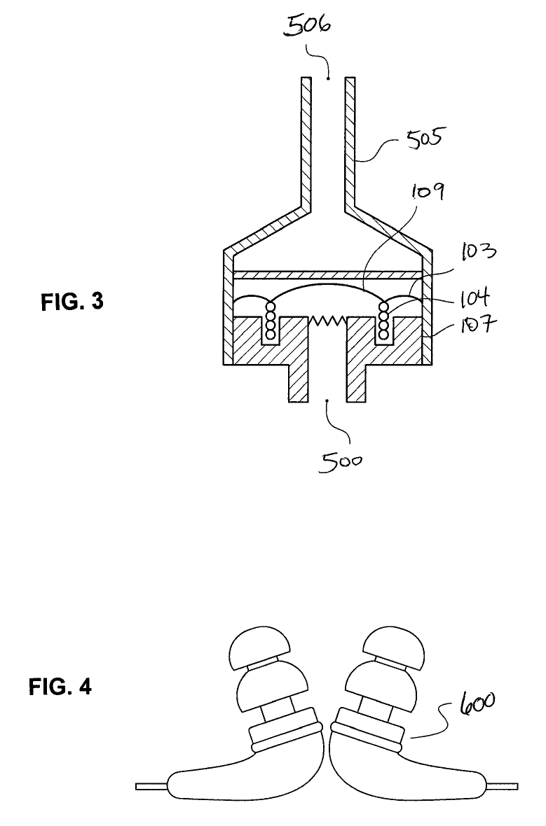

FIG. 3 shows an exemplary earpiece which may accept the transducer of the present invention. Given placement of the transducer, the transducer is capable of generating high quality tones with minimal distortion.

In FIG. 3, a vent hole 500 is placed in the transducer such that ventilation occurs into the transducer through the filter media placed within the interior of the transducer. In an embodiment, the acoustic filter may be used to filter material and prevent material from entering the interior of the transducer. A sound port 506 is located at alternate distal end to the vent hole of the transducer such that sound that is produced in the transducer is allowed to escape for later use. In the example embodiment, the sound port has an elongated exit allowing for tuning of the transducer to the required sound characteristics desired. Alternate configurations may be used for the sound port 506. Although shown as a round exit, the sound port 506 may be other geometric shapes as required by the auditory features required. The nozzle 505 of the sound port 506 may be shortened or elongated.

FIG. 4 shows an example earphone with an example ear fitament or fitting 600.

An example transducer according to the present invention allows for superior bass production as compared to available transducer models.

An embodiment of the present invention also solves the long felt industry need of providing a transducer that has both a high quality bass response as well as being able to be produced in mass quantity. Conventional model transducers do not provide this capability of high quality sound reproduction while allowing for use of production.

The present invention also provides a superior transducer that will eliminate foreign materials from entering the body of the transducer thereby minimize internal component damage. This results in higher quality sound reproduction as well as extended use capability of the transducer 10 compared to conventional units.

Additionally, the present invention provides a transducer design that has proper bass response such that individuals will not need to increase volume levels while listening to oratory playback thereby preventing individuals from suffering hearing ailments such as tinnitus.

In an embodiment, the transducer provides a frequency response across the full audible spectrum of 20 Hz to 20 kHz with a sensitivity of 112 db at 30 Hz/1 mW. The transducer includes the same impedance level of 32 Ohms.

In an embodiment, the ring reduces the hole provided. In the present embodiment, the air space factor, e.g., the air space in front of the diaphragm, affects the sound quality.

In an embodiment, the size and material of the filter is chosen in view of the size of the transducer. The filter may be any variety of available materials. For example, the filter may be made of paper, a fine mesh woven polyester, a steel weave, etc.

In manufacturing, the filter was adhered to the front of the port hole so that in handling, the filter was not disturb by workers or machines.

The fittings between the parts may be a latch, screw, or other available bonding means, material, or mechanism.

The earphone device embodiment provides for an ear piece to fit to the meatus of a user's ear. In a further embodiment, the earphone device fits the external opening in a manner which essentially seals against the meatus or opening of the user so that external sounds are not necessarily heard or audibly distracting. The earphone device is not as useful on the outside of an ear. Instead, the intention is to get the sound into the canal, not the outer opening of an ear.

In an embodiment of the present invention, a tip of the ear piece shell includes a through hole to allow for transmission of sound to the external meatus. In an embodiment, a tip of the ear piece shell including a through hole allows for attachable, replaceable, and/or interchangeable ear fitments. For example, such ear fitments may be die-cut foam pieces, similar to that used in medical devices. Other such ear fitments may be injection-molded foam or plastic pieces. The ear fitments may be fitted onto a rod extending from the ear piece shell. In an embodiment of the present invention, an ear fitment and/or interchangeable tip may be a multi-flanged soft plastic plug, a slow recovery foam, or a custom-molded tip or ear fitment. The custom-molded tip or ear fitment may be made from a variety of available materials.

In an embodiment, an earphone device includes a transducer. The transducer has a rivet that mechanically fastens parts of the magnetic structure together. In an embodiment, the transducer has a rivet that creates a port onto which a dampener is fitted to control, for example, the resonant peak of the diaphragm. In an embodiment, the transducer is sealed off between the front and rear chambers. In an embodiment, the transducer is connected to a cable which connects to an external electrical sound source, e.g., a standard headphone amplifier, media player, music mixing console, or other appropriate sound source. In an embodiment, the transducer may also be used with a supplied microphone to supply audio for telephony and/or other purposes.

In an example embodiment, the transducer is manufactured to include a rivet through an axial center of a pole piece, a magnet, a printed circuit board, and a mounting structure. This manufacturing of the transducer provides a securement of the parts of the earphone device. This manufacturing of the transducer provides a dimensional port on which an acoustic dampener system may be affected. Accordingly, in an embodiment of the present invention, in order to be able to manufacture a more reliable product, a more appropriate acoustic dampener material and mounting method was developed. The acoustic dampener material needs to be a material which can fulfill multiple functions, including as a filter and as a resistance. In an embodiment, the acoustical dampener material is provided to have a specific acoustical resistance to match the needed resonant peak of a transducer as mounted in the ear piece. In an embodiment, the acoustic dampener material serves as a material filter which keeps out contaminants from the back of the voice coil, without clogging the air passage over time.

In an embodiment, a dynamic transducer is used to provide a greater dynamic range, less phase cancellation, and/or less transient distortion than armature type drivers. In an embodiment, a dynamic transducer is provided which supplies a voice coil in a magnetic gap provided by a magnet, a pole piece, and an outer mounting shell of the dynamic transducer. For example, the voice coil is driven by an external sound source. The voice coil acts on the diaphragm causing the diaphragm to move in relation to the electrical energy supplied by the external source. The diaphragm thus creates acoustical energy.

In an embodiment, using a dynamic transducer provides an earphone device which can transmit sound without the drawbacks of using multiple drivers and/or crossover networks creating phase cancellation problems. In an embodiment, using a dynamic transducer provides a reproduction of sound by the transducer with less inter-modulation distortion product(s).

In an embodiment of the present invention, a dampener mounted adjacent to a diaphragm may serve to keep contaminants out of the voice coil. Further, the dampener provides an acoustical filter.

In embodiments of the present invention, attachments between the various part(s) of the earphone device may include glue, adhesive, ultrasonic welding, latch, screw, snap fixturing, or other available bonding means, material, or mechanism. For example, an attachment involving a non-metal part, e.g., a plastic part, can be effected using ultrasonic welding. For example, an attachment involving a metal part, e.g., a circuit board, can be effected using glue or adhesive. The transducer is sealed tightly. For example, the transducer may be sealed with an epoxy.

In earlier embodiments, in a transducer, a filter material inside the port opening may be, for example, a reticulated foam or fine screen material. However, such insertions are time consuming and did not produce consistent results. In an embodiment of the present invention, a fine mesh material is fixed to a front section of the port opening of the transducer. For example, a fine mesh material may be adhesively fixed to the front of the port opening. By adhesively fixing an appropriate fine mesh material to a port opening (i.e., the front and/or back side of the port opening) of the magnet structure of the transducer of an earphone device, a more stable filter is provided.

For manufacturing process, affixing a material, e.g., a fine mesh material, to a port opening may be put on either opening of the port. The material may be affixed on the front or back of the hole or port, and/or may be affixed to the front or back of the magnet.

In an embodiment of the present invention, a rivet or other hollow structure may be used to define the space. The motor structure and magnet structure may surround the rivet or a hollow structure which is provided or formed by the other parts of the transducer.

In an embodiment of the present invention, the single port hole as described in earlier embodiments provides not only a filter that raises the low frequency bands, but also places a comb filter close to the band where normally there is a loss of amplitude due to the lack of the soft parts of the ear. It affects the sound whether the earphone is used inside the ear near the hearing canal, or external to the ear.

An embodiment of the present invention allows for a changing of sound by a changing of the opening size in the audio aperture. In an embodiment, the audio aperture here refers to the diaphragm cover having one opening. Embodiments of the present invention provide for a unique sound and range response when using one central hole through which air is pushed. The air space between the diaphragm is squeeze out through the central hole. In an embodiment of the present invention, the audio aperture is a solid piece of metal with a hole in the center. The sound is affected by the amount of air spaces of the diaphragm and where the air is being pushed to the face plate where there are more air spaces.

An embodiment of the audio aperture changes sound. The audio aperture holds the diaphragm in and between the motor structure. It makes for a cohesive transducer. Further it protects the diaphragm from being crushed. The single hole in the audio aperture changes the sound. Further, the glue holding the diaphragm comes undone over time, but the metal cover or audio aperture puts pressure on the diaphragm which allows for a more consistent audio response.

Embodiments of the present invention provide for an earphone having a larger range at a lower volume level. The embodiments provide for a wider dynamic range to lower volume level. Embodiments of the present invention provide for a better acoustical experience. Embodiments of the present invention provide for a wider dynamic range using a lower volume level than in earlier embodiments. Embodiments of the present invention provide for a control of the bass response transducer.

In the foregoing specification, various embodiments of the present invention have been described. Those embodiments may be used with and without each other in various combinations. In addition, various modifications and changes may be made to the example embodiments described above without departing from the broader spirit and scope of the invention. The specification and drawings are provided for illustrative purposes and not meant to limit the scope of the invention.

What is claimed is:

1. A device comprising:
a nozzle; and
a transducer having:
a magnet structure;
a motor structure;
an audio aperture; and
an acoustic filter,
wherein the audio aperture is mounted on the motor structure, the motor structure coupled to the magnet structure, wherein the acoustic filter is adhered to the magnet structure.
